(19) United States
(12) Patent Application Publication
(10) Pub. No.: US 2006/0238677 A1
(43) Pub. Date: Oct. 26, 2006

(54) Display panel, method of manufacturing the same and display device having the same

(75) Inventors: Sin-Doo Lee, Seoul (KR); Jin-Yool Kim, Seoul (KR); Yong-Woon Lim, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/403,363

(22) Filed: Apr. 13, 2006

(30) Foreign Application Priority Data
Apr. 22, 2005 (KR) 2005-33523

(51) Int. Cl. G02F 1/1335

(52) U.S. Cl. 349/114

(57) ABSTRACT

A display panel includes a first substrate member, a second substrate member, a liquid crystal layer and a phase difference layer. The first substrate member includes a first substrate and a pixel electrode part on the first substrate. The pixel electrode part transmits an internally provided light, and reflects an externally provided light. The second substrate member includes a second substrate corresponding to the first substrate and a common electrode on the second substrate. The liquid crystal layer is interposed between the first and second substrate members. The phase difference layer is between the first and second substrates to change phases of the internally and externally provided lights by different amounts. Therefore, an image display quality is improved, and a manufacturing process is simplified.

### CROSS-REFERENCE TO RELATED APPLICATION

The present application claims priority from Korean Patent Application No. 2005-33523, filed on Apr. 22, 2005, the disclosure of which is hereby incorporated herein by reference in its entirety.

### BACKGROUND OF THE INVENTION

1. Technical Field

The present disclosure relates to a display panel, and, more particularly, to a display panel capable of simplifying a manufacturing process, a method of manufacturing the display panel and a display device having the display panel.

2. Discussion of the Related Art

A liquid crystal display (LCD) device can be classified into a transmissive type LCD device and a reflective type LCD device. The transmissive type LCD device displays an image using an internally provided light generated from a backlight assembly. The reflective type LCD device displays the image using an externally provided light such as sunlight.

The transmissive type LCD device can display an image although the transmissive type LCD device is in a dark place. However, power consumption of the transmissive type LCD device is larger than that of the reflective type LCD device, and an image display quality of the transmissive type LCD device is deteriorated by reflection of externally provided light, for example, in a bright place.

The reflective type LCD device has a smaller power consumption than the transmissive type LCD device. In addition, the image display quality of the reflective type LCD device is not deteriorated by reflection of externally provided light in, for example, a bright place. The reflective type LCD device does not display an image in a dark place.

A reflective-transmissive LCD device has been developed to display an image of a high quality in a dark place and in a bright place.

The reflective-transmissive LCD device includes an LCD panel and a backlight assembly. The LCD panel displays the image using internally provided light and externally provided light. The backlight assembly supplies the LCD panel with the internally provided light. The LCD panel includes a plurality of pixels for displaying the image. Each of the pixels includes a transmission region where the internally provided light passes and a reflection region where the externally provided light is reflected. The transmission region has a different light path from the reflection region so that optical anisotropy is formed between the internally and externally provided lights.

Reflection and transmission regions in a conventional reflective-transmissive LCD device have different thicknesses so that the reflection and transmission regions have a substantially same optical anisotropy.

When the reflective-transmissive LCD device has the reflection and transmission with the different thicknesses, a manufacturing process is complex and a manufacturing cost is increased.

### SUMMARY OF THE INVENTION

Embodiments of the present invention provide a display panel capable of simplifying a manufacturing process, a method of manufacturing the display panel and a display device having the display panel.

A display panel in accordance with an embodiment of the present invention includes a first substrate member, a second substrate member, a liquid crystal layer and a phase difference layer. The first substrate member includes a first substrate and a pixel electrode part on the first substrate. The pixel electrode part transmits an internally provided light, and reflects an externally provided light. The second substrate member includes a second substrate corresponding to the first substrate and a common electrode on the second substrate. The liquid crystal layer is interposed between the first and second substrate members. The phase difference layer is between the first and second substrates to change phases of the internally and externally provided lights by different amounts.

A method of manufacturing a display panel in accordance with an embodiment of the present invention is provided. A pixel electrode part is formed on a first substrate. The pixel electrode transmits an internally provided light and reflects an externally provided light. A common electrode corresponding to the pixel electrode part is formed on a second substrate. At least one phase difference layer is formed on at least one of a pixel electrode part or a common electrode to change phases of the internally and externally provided lights by different amounts.

A display device in accordance with an embodiment of the present invention includes a backlight assembly and a display panel. The backlight assembly generates an internally provided light. The display panel includes a first substrate member, a second substrate member, a liquid crystal layer and a phase difference layer. The first substrate member includes a first substrate and a pixel electrode part on the first substrate. The pixel electrode part transmits the internally provided light, and reflects an externally provided light. The second substrate member includes a second substrate corresponding to the first substrate and a common electrode on the second substrate. The liquid crystal layer is interposed between the first and second substrate members. The phase difference layer is between the first and second substrates to change phases of the internally and externally provided lights by different amounts.

According to the embodiments of present invention, the phase difference layer is formed to compensate for the optical anisotropies of the display panel. As a result, an image display quality of the display panel is improved, and a manufacturing process of the display panel is simplified.

### BRIEF DESCRIPTION OF THE DRAWINGS

Exemplary embodiments of the present invention can be understood in more detail from the following descriptions taken in conjunction with the accompanying drawings, in which:

FIG. 1 is an exploded perspective view showing a display device in accordance with an embodiment of the present invention;

FIG. 2 is an exploded perspective view showing a pixel of a display panel of the display device shown in FIG. 1;

FIG. 3 is a plan view showing a switching element and a pixel electrode part of a display panel of the display device shown in FIG. 1;

FIG. 4 is an exploded perspective view showing an operation of the pixel shown in FIG. 2 when an electric power is not applied to the pixel;

FIG. 5 is an exploded perspective view showing an operation of the pixel shown in FIG. 2 when an electric power is applied to the pixel;

FIG. 6 is an exploded perspective view showing a pixel of a display panel of a display device in accordance with an embodiment of the present invention;

FIG. 7 is an exploded perspective view showing an operation of the pixel shown in FIG. 6 when an electric power is not applied to the pixel;

FIG. 8 is an exploded perspective view showing an operation of the pixel shown in FIG. 6 when an electric power is applied to the pixel; and

FIGS. 9A to 9G are cross-sectional views showing a method of manufacturing a display panel in accordance with an embodiment of the present invention.

### DESCRIPTION OF THE EXEMPLARY EMBODIMENTS

Exemplary embodiments of the present invention are described more fully hereinafter with reference to the accompanying drawings. This invention may, however, be embodied in many different forms and should not be construed as limited to the embodiments set forth herein.

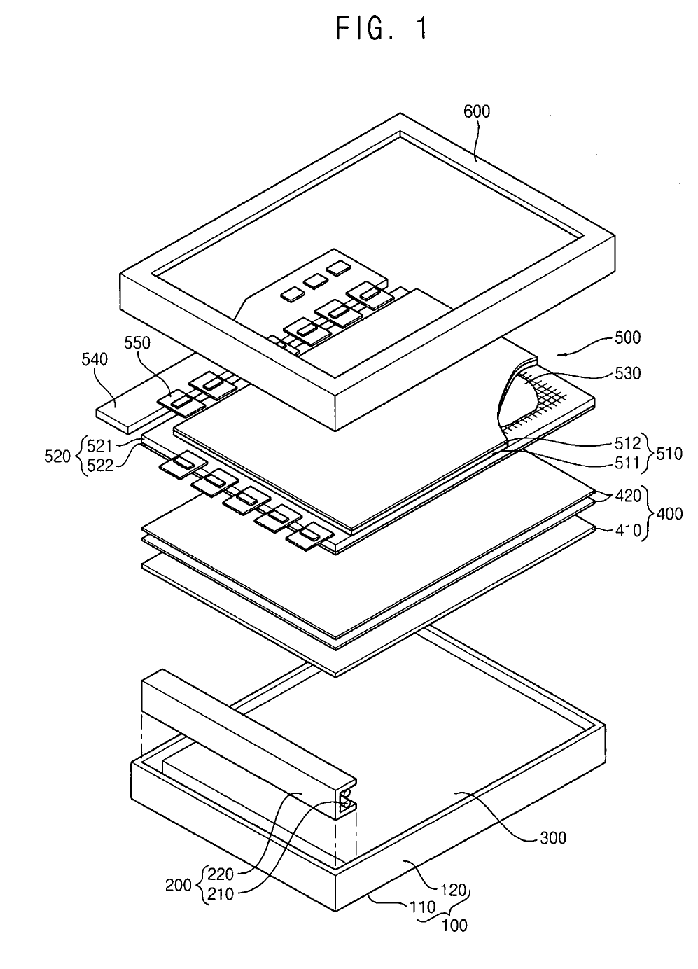

FIG. 1 is an exploded perspective view showing a display device in accordance with an embodiment of the present invention.

Referring to FIG. 1, the display device includes a backlight assembly, optical sheets 400, a display panel 500 and a top chassis 600.

The backlight assembly provides the display panel 500 with an internally provided light. The backlight assembly includes a receiving container 100, a light generating unit 200 and a light guiding plate 300.

The receiving container 100 includes a bottom plate 110 and sidewalls 120 that are protruded from sides of the bottom plate 110 to form a receiving space. The light generating unit 200 and the light guiding plate 300 are received in the receiving space.

The light generating unit 200 is received in the receiving container 100, and corresponds to a side of the light guiding plate 300. The light generating unit 200 includes a lamp 210 and a lamp cover 220 that covers the lamp 210. The lamp 210 has a cold cathode fluorescent lamp (CCFL) that has a rod shape. The lamp cover 220 covers a portion of the lamp 210. A portion of the light generated from the lamp 210 is reflected from the lamp cover 220 toward the light guiding plate 300.

The light guiding plate 300 is received in the receiving container 100. A side of the light guiding plate 300 corresponds to the light generating unit 200. The light guiding plate 300 receives the light generated from the lamp 210 through the side, and guides the light toward an upper surface of the light guiding plate 300. In particular, the light is reflected and refracted from surfaces of the light guiding plate 300 toward the upper surface of the light guiding plate 300. A reflective pattern (not shown) may be formed on a lower surface of the light guiding plate 300.

The light guiding plate 300 may have a wedge shape. A thickness of the light guiding plate 300 is decreased as a distance from the light generating unit 200 is increased. Alternatively, the light guiding plate 300 may have a substantially flat plate shape, and two light generating units 200 may be positioned on opposite sides of the light guiding plate 300.

The optical sheets 400 are positioned on the backlight assembly to improve optical characteristics of the light that has passed through the light guiding plate 300. The optical sheets 400 include a diffusion plate 410 and a prism sheet 420. The diffusion plate 410 diffuses the light that has passed through the light guiding plate 300. The prism sheet 420 increases a luminance of the backlight assembly when viewed on a plane. The prism sheet 420 may be a brightness enhancement film.

The display panel 500 is positioned on the optical sheets 400. The display panel 500 displays an image using the internally provided light and an externally provided light such as, for example, sunlight and ambient light. The display panel 500 includes a first substrate member 510, a second substrate member 520, a liquid crystal layer 530, a printed circuit board 540 and a flexible printed circuit board 550.

The first substrate member 510 includes a first substrate 511 and a first polarizer 512. The first substrate 510 includes a plurality of pixel electrode parts, a plurality of thin film transistors and a plurality of signal lines. The pixel electrode parts are arranged in a matrix shape. Each of the thin film transistors applies a driving voltage to each of the pixel electrode parts. The signal lines transmit the driving signals to the thin film transistors. The first polarizer 512 is positioned under the first substrate 511 to polarize the internally provided light in a first polarizing direction.

The second substrate member 520 corresponds to the first substrate member 510. The second substrate member 520 is arranged so as to face the first substrate member 510. The second substrate member 520 includes a second substrate 521 and a second polarizer 522. The second substrate 521 includes a common electrode and a plurality of color filters. The common electrode is on substantially the entire second substrate 521, and includes a transparent conductive material. The color filters correspond to the pixel electrode parts. The second polarizer 522 is on the second substrate 521 to polarize light that has passed through the second substrate 521 in a second polarizing direction. The second polarizing direction may be substantially perpendicular to the first polarizing direction.

The liquid crystal layer 530 is interposed between the first and second substrate members 510 and 520. Liquid crystals of the liquid crystal layer 530 vary their arrangement in response to an electric field formed between the pixel electrode parts and the common electrode. As a result, a light transmittance of the liquid crystal layer 530 is changed. The light passes through the color filter to display an image.

The printed circuit board 540 includes a driving circuit unit that processes an image signal. The driving circuit unit changes the image signal into the driving signal that controls each of the thin film transistors.

The printed circuit board 540 is electrically connected to the first substrate member 510 through the flexible printed circuit board 550 so that the driving signal that is generated from the printed circuit board 540 is applied to the first substrate member 510. The flexible printed circuit board 550 is bent so that the printed circuit board 540 is on a side or a rear surface of the display panel 500.

The top chassis 600 surrounds a peripheral portion of the display panel 500 to be combined with the sidewalls 120 of the receiving container 100 so that the display panel 500 is fixed to the backlight assembly. The top chassis 600 protects the display panel 500 from an externally provided impact. In addition, the top chassis 600 prevents drifting of the display panel 500.

In FIG. 1, the backlight assembly is an edge illumination type backlight assembly. Alternatively, the backlight assembly may be a direct illumination type backlight assembly that includes a plurality of lamps arranged substantially parallel with each other.

In FIG. 1, the light generating unit 200 is the CCFL having the rod shape. Alternatively, the light generating unit 200 may include a light emitting diode (LED).

FIG. 1 shows a display device that is used for a device such as a notebook computer. However, the display device may be used for other devices, such as, for example, a cellular phone.

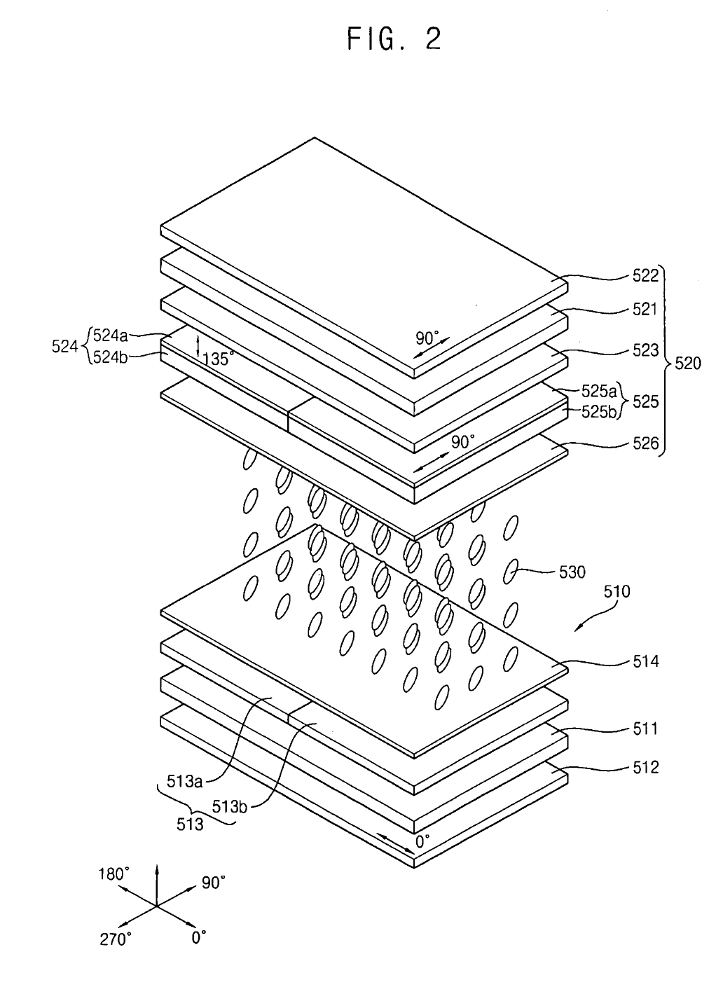

FIG. 2 is an exploded perspective view showing a pixel of a display panel of the display device shown in FIG. 1.

Referring to FIG. 2, the display panel 500 includes a plurality of pixels. The first substrate member 510, the second substrate member 520 and the liquid crystal layer 530 form the pixels.

The first substrate member 510 includes the first substrate 511, the first polarizer 512, the thin film transistors (not shown), the pixel electrode parts 513 and a first liquid crystal alignment layer 514.

The first substrate 511 has a plate shape. The first substrate 511 may include a transparent material. Examples of the transparent material that can be used for the first substrate 511 include glass and quartz.

The first polarizer 512 is positioned under the first substrate 511, and polarizes the light in the first polarizing direction. For example, the first polarizing direction may be about 0° or about 180° with respect to a longitudinal direction of the first substrate 511. A backlight assembly that generates the internally provided light is positioned under the first polarizer 512. The internally provided light is polarized about 0° or about 180° with respect to the longitudinal direction of the first substrate 511 by the first polarizer 512.

The thin film transistors are positioned on the first substrate 511. Each of the thin film transistors is electrically connected to each of the pixel electrode parts 513. The driving voltage is applied to each of the pixel electrode parts 513 through each of the thin film transistors.

The pixel electrode parts 513 are positioned on the first substrate 511 having the thin film transistors. Each of the pixel electrode parts 513 includes a transmission electrode 513a and a reflection electrode 513b. For example, the transmission electrode 513a may have substantially the same area as the reflection electrode 513b. The area of each of the transmission and reflection electrodes 513a and 513b may be about half of each of the pixel electrode parts 513.

The transmission electrode 513a is in a transmission region of each of the pixel electrode parts 513. The transmission electrode 513a transmits a portion of the internally provided light generated from the backlight assembly. The transmission electrode 513a includes a transparent conductive material. Examples of the transparent conductive material that can be used for the transmission electrode 513a include indium tin oxide (ITO), indium zinc oxide (IZO), and amorphous indium tin oxide (a-ITO). The transmission electrode 513a may be formed through a photolithography process.

The reflection electrode 513b is in a reflection region of each of the pixel electrode parts 513. The externally provided light is reflected from the reflection electrode 513b. The reflection electrode 513b may include a highly reflective material.

The first liquid crystal alignment layer 514 is positioned on the first substrate 511 having the pixel electrode parts 513. The first liquid crystal alignment layer 514 aligns the liquid crystals of the liquid crystal layer 530 in an alignment direction. For example, the alignment direction may be about 45° with respect to the longitudinal direction of the first substrate 511.

The second substrate member 520 corresponds to the first substrate member 510. The second substrate member 520 includes a second substrate 521, a second polarizer 522, a color filter (not shown), a common electrode 523, a phase difference layer and a second alignment layer 526.

The second substrate 521 has a plane shape. The second substrate 521 may have substantially the same shape as the first substrate 511. The second substrate 521 may include a transparent material. Examples of the transparent material that can be used for the second substrate 521 include glass and quartz.

The second polarizer 522 is positioned on the second substrate 521, and polarizes the light in the second polarizing direction. For example, the second polarizing direction may be about 90° or about 270° with respect to a longitudinal direction of the second substrate 521. The second substrate 521 may have substantially the same longitudinal direction as the first substrate 511. The internally provided light or the externally provided light is polarized about 90° or about 270° with respect to the longitudinal direction of the second substrate 521 by the second polarizer 522.

The color filter is formed on the second substrate 521 corresponding to the first substrate 511. A portion of the internally provided light or the externally provided light having a predetermined wavelength may pass through the color filter. The color filter includes a red color filter portion, a green color filter portion and a blue color filter portion. The red, green and blue color filter portions transmit a red light, a green light and a blue light, respectively.

The common electrode 523 is positioned on the second substrate 521 having the color filter. The common electrode 523 includes a transparent conductive material. Examples of the transparent conductive material that can be used for the common electrode 523 include indium tin oxide (ITO), indium zinc oxide (IZO), and amorphous indium tin oxide (a-ITO). The common electrode 523 may be formed through a photolithography process.

The phase difference layer is formed on the common electrode 523. The phase difference layer includes a first phase difference part 524 and a second phase difference part 525. The first phase difference part 524 corresponds to the transmission region. The second phase difference part 525 corresponds to the reflection region. The phase difference layer compensates for differences of optical anisotropies formed by differences of a light path of the internally provided light and a light path of the externally provided light.

The first phase difference part 524 corresponds to the transmission region. The internally provided light passes through the first phase difference part 524. The first phase difference part 524 includes a first guiding layer 524a and a first optical anisotropy layer 524b. The first phase difference part 524 may have substantially the same optical longitudinal direction as the first or second polarizers 512 and 522.

The first guiding layer 524a is positioned on a lower surface of the common electrode 523 to guide the optical longitudinal direction of the first optical anisotropy layer 524b. The first guiding layer 524a may be surface-treated in the optical longitudinal direction. The first guiding layer 524a may be formed through, for example, a coating process and/or a deposition process. The first guiding layer 524a may include a high polymer. Examples of the high polymer that can be used for the first guiding layer 524a include SE-7492 (trade name, manufactured by Nissan Chemical Corporation, Japan), and JALS203 (trade name, manufactured by JSR Corporation, Japan).

An electromagnetic wave such as an ultraviolet light is irradiated onto the first guiding layer 524a to surface-treat the first guiding layer 524a. In particular, a polarized ultraviolet light is irradiated onto the first guiding layer 524a so that the first guiding layer 524a has an anisotropy.

The first optical anisotropy layer 524b is positioned on a lower surface of the first guiding layer 524a to change a phase of the internally provided light. A longitudinal axis of the first optical anisotropy layer 524b may be determined based on the surface-treatment of the first guiding layer 524a. For example, the longitudinal axis of the first optical anisotropy layer 524b may be about 135° with respect to the longitudinal direction of the second substrate 521.

The first optical anisotropy layer 524b includes an optical anisotropy material. For example, the first optical anisotropy layer 524b includes a light curable liquid crystal material. The first optical anisotropy layer 524b may be formed on the first guiding layer 524a through, for example, a spin coating process or a roll coating process, and then solidified by an ultraviolet light.

The optical anisotropy material may be a mixture of the light curable liquid crystal material and a solvent. Examples of the solvent that can be used for the optical anisotropy material include propylene glycol methylethyl acetate, chloroform, and chlorobenzene. These solvents can be used alone or in a combination thereof. Examples of the light curable liquid crystal material that can be used for the optical anisotropy material include RMM34 manufactured by Merck Corporation, Germany, and LC298 manufactured by BASF Corporation, Germany. A volumetric ratio of the light curable liquid crystal material in the optical anisotropy material may be about 10% to about 20%.

The first optical anisotropy layer 524b converts a linearly polarized portion of the internally provided light into an elliptically polarized portion. Alternatively, the first optical anisotropy layer 524b may convert an elliptically polarized portion of the internally provided light into a linearly polarized portion. The first optical anisotropy layer 524b changes a phase of the internally provided light by about 1/10λ to about ½λ. For example, the first optical anisotropy layer 524b may change the phase of the internally provided light by about ¼λ.

The second phase difference part 525 corresponds to the reflection region. The externally provided light passes through the second phase difference part 525. The second phase difference part 525 includes a second guiding layer 525a and a second optical anisotropy layer 525b. The second phase difference part 525 may have substantially the same optical longitudinal direction as the first or second polarizers 512 and 522.

The second guiding layer 525a is positioned on a lower surface of the common electrode 523 to guide the optical longitudinal direction of the second optical anisotropy layer 525b. The second guiding layer 525a may be surface-treated in an optical longitudinal direction that is different from the optical longitudinal direction of the first guiding layer 524a. The second guiding layer 525a may be formed through, for example, a coating process and/or a deposition process. The second guiding layer 525a may include substantially the same material as the first guiding layer 524a. An electromagnetic wave such as an ultraviolet light is irradiated onto the second guiding layer 525a to surface-treat the second guiding layer 525a.

The second optical anisotropy layer 525b is positioned on a lower surface of the second guiding layer 525a to change a phase of the internally provided light. A longitudinal axis of the second optical anisotropy layer 525b may be determined based on the surface-treatment of the second guiding layer 525a. For example, the longitudinal axis of the second optical anisotropy layer 525b may be about 45° or about 135° with respect to the longitudinal axis of the first optical anisotropy layer 524b. For example, the longitudinal axis of the second optical anisotropy layer 525b may be about 90° with respect to the optical longitudinal direction of the first optical anisotropy layer 524b.

The second optical anisotropy layer 525b includes an optical anisotropy material. For example, the second optical anisotropy layer 525b may include substantially the same light curable liquid crystal material as the first optical anisotropy layer 524b.

The second optical anisotropy layer 525b converts a linearly polarized portion of the internally provided light into an elliptically polarized portion. Alternatively, the second optical anisotropy layer 525b may convert an elliptically polarized portion of the internally provided light into a linearly polarized portion. The second optical anisotropy layer 525b changes a phase of the internally provided light by about 1/10λ to about ½λ. For example, the second optical anisotropy layer 525b may change the phase of the internally provided light by about ¼λ.

The second liquid crystal alignment layer 526 is positioned on a lower surface of the phase difference layer to determine an alignment direction of the liquid crystal layer 530. The alignment direction of the second liquid crystal alignment layer 526 may be about 180° with respect to the alignment direction of the first liquid crystal alignment layer 514. Alternatively, the alignment direction of the second liquid crystal alignment layer 526 may form be 225° with respect to the alignment direction of the first liquid crystal alignment layer 514.

The liquid crystal layer 530 is interposed between the first substrate member 510 and the second substrate member 520. The liquid crystals of the liquid crystal layer 530 vary their arrangement in response to the electric field applied between the pixel electrode parts 513 and the common electrode 523. The liquid crystals may have a positive dielectric anisotropy. A thickness of the liquid crystal layer 530 is adjusted so that the liquid crystal layer 530 has an optical anisotropy of about ¼λ. The liquid crystal layer 530 may have a horizontal alignment mode. Alternatively, the liquid crystal layer 530 may have a vertical alignment mode.

A protecting layer (not shown) may be formed between the phase difference layer and the second liquid crystal alignment layer 526 to protect the phase difference layer.

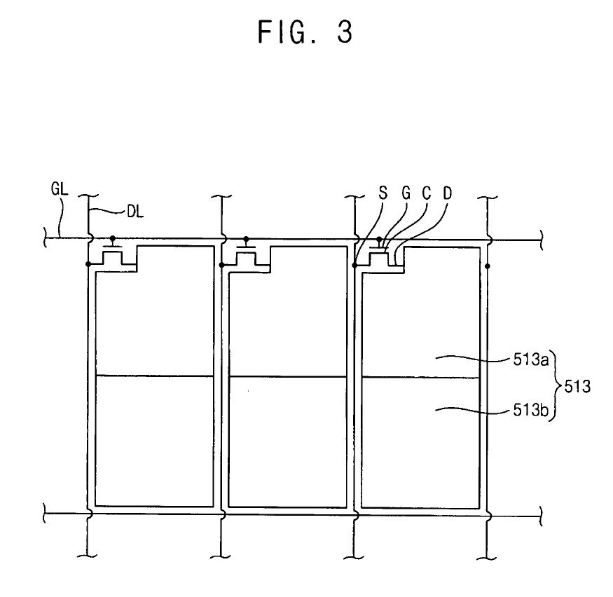

FIG. 3 is a plan view showing a switching element and a pixel electrode part of a display panel of the display device shown in FIG. 1.

Referring to FIGS. 1 to 3, the first substrate 511 includes a data line DL, a gate line GL, the thin film transistors and the pixel electrode parts 513. The first substrate 511 may further include a plurality of data lines and a plurality of gate lines.

The data lines cross the gate lines. A source signal is applied to each of the data lines, and a gate signal is applied to each of the gate lines.

Each of the thin film transistors includes a source electrode S, a gate electrode G, a drain electrode D and a channel layer C. The source electrode S is electrically connected to one of the data lines DL to receive the source signal. The gate electrode G is electrically connected to one of the gate lines GL to receive the gate signal. A channel is formed in the channel layer C between the source electrode S and the drain electrode D so that the source electrode S is electrically connected to the drain electrode D. The source signal is applied to each of the pixel electrode parts 513 through the source electrode S.

Each of the pixel electrode parts 513 is electrically connected to the drain electrode D. Each of the pixel electrode parts includes the transmission electrode 513a and the reflection electrode 513b. The transmission electrode 513a transmits the internally provided light, and corresponds to the transmission region. The reflection electrode 513b corresponds to the reflection region. The externally provided light is reflected from the reflection electrode 513b. The area of each of the transmission and reflection electrodes 513a and 513b may be about half of each of the pixel electrode parts 513.

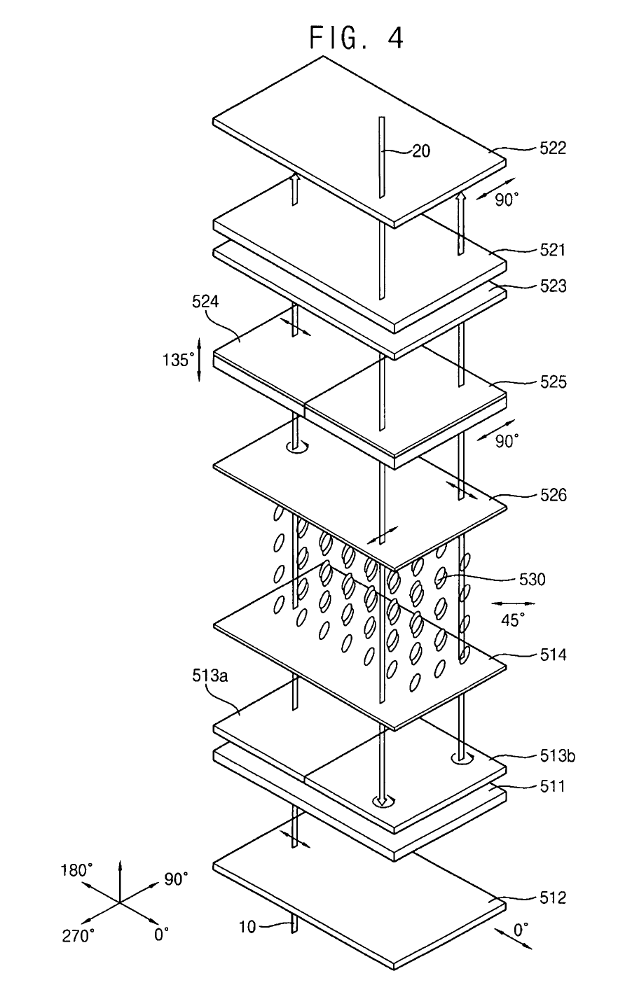

FIG. 4 is an exploded perspective view showing an operation of the pixel shown in FIG. 2 when electric power is not applied to the pixel. In FIG. 4, the electric power is not applied to the pixel, and the liquid crystal layer functions as a ¼λ phase difference layer that converts a linearly polarized light into a circularly polarized light. Light paths of the internally provided light generated from the backlight and the externally provided light are described, in sequence.

Referring to FIGS. 2 and 4, the internally provided light 10 generated from the backlight assembly passes through the first polarizer 512 to be linearly polarized about 0° or about 180° with respect to the longitudinal direction of the first substrate 511. The linearly polarized light passes through the first substrate 511, the transmission electrode 513a of each of the pixel electrode parts 513 and the first liquid crystal alignment layer 514, in sequence. The linearly polarized light having passed through the first substrate 511, the transmission electrode 513a and the first liquid crystal alignment layer 514 is incident into the liquid crystal layer 530 having a longitudinal axis of about 45° or about 225° to be circularly polarized. The circularly polarized light passes through the second liquid crystal alignment layer 526 and the first phase difference part 524 having a longitudinal axis of about 135° or about 315° to be linearly polarized about 0° or about 180°. The linearly polarized light passes through the common electrode 523 and the second substrate 521. The linearly polarized light having passed through the common electrode 523 and the second substrate 521 is blocked by the second polarizer 522 having the polarizing direction of about 90° or about 270°.

The externally provided light 20 passes through the second polarizer 522 to be linearly polarized about 90° or about 270° with respect to the longitudinal direction of the first substrate 511. The linearly polarized light passes through the second substrate 521, the common electrode 523, the second phase difference part 525 and the second liquid crystal alignment layer 526, in sequence. The phase of the linearly polarized light is not changed by the second phase difference part 525. The linearly polarized light having passed through the second substrate 521, the common electrode 523, the second phase difference part 525 and the second liquid crystal alignment layer 526 is incident into the liquid crystal layer 530 having the longitudinal axis of about 45° or about 225° to be circularly polarized. The circularly polarized light (original circularly polarized light) passes through the first liquid crystal alignment layer 514, and is reflected from the reflection electrode 513b. The reflected circularly polarized light has a substantially opposite direction to the original circularly polarized light.

The reflected circularly polarized light passes through the first liquid crystal alignment layer 514, and is incident into the liquid crystal layer 530. The reflected circularly polarized light passes through the liquid crystal layer 530 to be linearly polarized about 0° or about 180°. The linearly polarized light passes through the common electrode 523 and the second substrate 521. The linearly polarized light having passed through the common electrode 523 and the second substrate 521 is blocked by the second polarizer 522 having the polarizing direction of about 90° or about 270°.

Therefore, when the electric power is not applied to the pixel, the internally provided light 10 and the externally provided light 20 are blocked by the second polarizer 522 to display a black image.

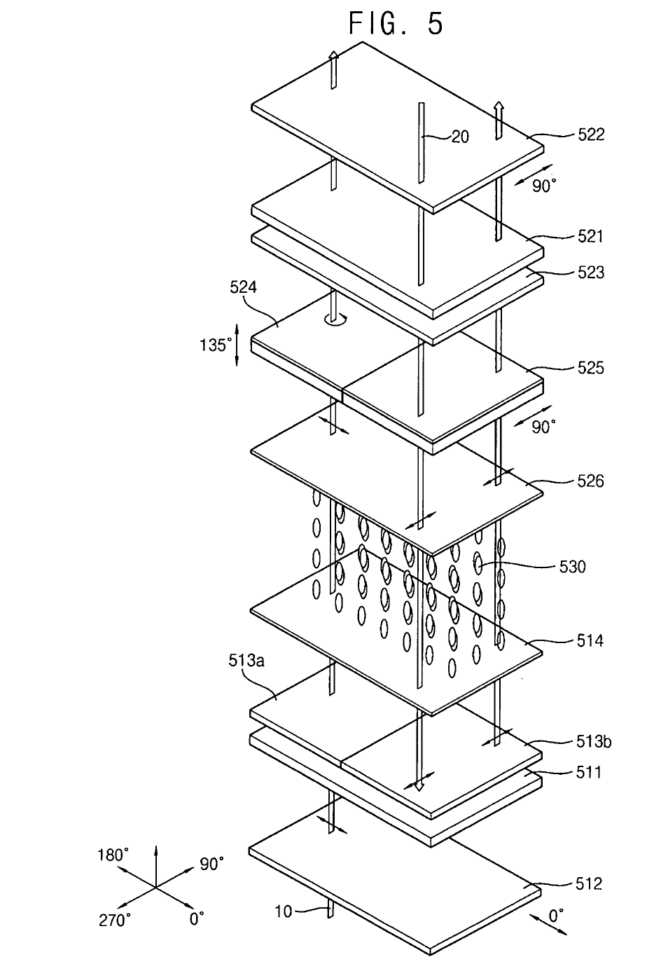

FIG. 5 is an exploded perspective view showing an operation of the pixel shown in FIG. 2 when electric power is applied to the pixel. In FIG. 5, the electric power is applied to the pixel, and the liquid crystal layer has a vertical alignment mode that transmits the internally provided light or the externally provided light. Light paths of the internally provided light generated from the backlight and the externally provided light are described, in sequence.

Referring to FIGS. 2 and 5, the internally provided light 10 generated from the backlight assembly passes through the first polarizer 512 to be linearly polarized about 0° or about 180° with respect to the longitudinal direction of the first substrate 511. The linearly polarized light passes through the first substrate 511, the transmission electrode 513a and the first liquid crystal alignment layer 514, in sequence. The linearly polarized light having passed through the first substrate 511, the transmission electrode 513a and the first liquid crystal alignment layer 514 also passes through the liquid crystal layer 530 having the vertical alignment mode. The linearly polarized light passes through the second liquid crystal alignment layer 526 and the first phase difference part 524 having a longitudinal axis of about 135° or about 315° to be circularly polarized. The circularly polarized light passes through the common electrode 523 and the second substrate 521. The circularly polarized light having passed through the common electrode 523 and the second substrate 521 also passes through the second polarizer 522 having the polarizing direction of about 90° or about 270°.

The externally provided light 20 passes through the second polarizer 522 to be linearly polarized about 90° or about 270° with respect to the longitudinal direction of the first substrate 511. The linearly polarized light passes through the second substrate 521, the common electrode 523, the second phase difference part 525 and the second liquid crystal alignment layer 526, in sequence. The phase of the linearly polarized light is not changed by the second phase difference part 525. The linearly polarized light having passed through the second substrate 521, the common electrode 523, the second phase difference part 525 and the second liquid crystal alignment layer 526 also passes through the liquid crystal layer 530. The linearly polarized light (original linearly polarized light) passes through the first liquid crystal alignment layer 514, and is reflected from the reflection electrode 513b. The reflected linearly polarized light may have substantially the same polarizing direction as the original linearly polarized light.

The reflected linearly polarized light passes through the first liquid crystal alignment layer 514, and is incident into the liquid crystal layer 530. The reflected linearly polarized light passes through the liquid crystal layer 530. The linearly polarized light passes through the second liquid crystal alignment layer 526, the second phase difference layer 525, the common electrode 523 and the second substrate 521. The linearly polarized light having passed through the second liquid crystal alignment layer 526, the second phase difference layer 525, the common electrode 523 and the second substrate 521 also passes through the second polarizer 522 having the polarizing direction of about 90° or about 270°.

Therefore, when electric power is applied to the pixel, the internally provided light 10 and the externally provided light 20 pass through the second polarizer 522 to display a white image.

In addition, an amount of the electric power applied to the pixel is adjusted to control a gray-scale of the image. Usually, a voltage between the voltage that is applied in a bright state and the voltage that is applied in a dark state is applied to obtain the gray-scale image.

Referring to FIGS. 4 and 5, when electric power is not applied to the pixel, the liquid crystal layer 530 functions as the ¼λ phase different layer that converts the linearly polarized light into the circularly polarized light. In addition, when electric power is applied to the pixel, the liquid crystal layer 530 transmits the linearly polarized light. Alternatively, when electric power is not applied to the pixel, the liquid crystal layer may transmit the linearly polarized light, and, when electric power is applied to the pixel, the liquid crystal layer may function as the ¼λ phase different layer that converts the linearly polarized light into the circularly polarized light.

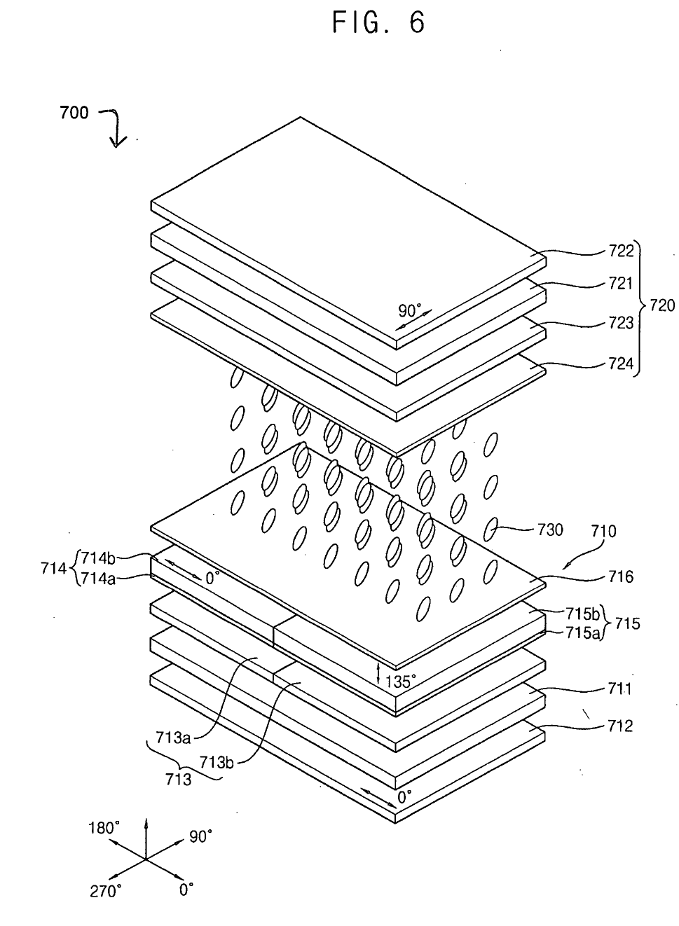

FIG. 6 is an exploded perspective view showing a pixel of a display panel of a display device in accordance with another embodiment of the present invention. The display device of FIG. 6 is substantially the same as in FIGS. 1 to 5.

Referring to FIGS. 1 and 6, the display panel 700 includes a first substrate member 710, a second substrate member 720 and a liquid crystal layer 730. The first substrate member 710, the second substrate member 720 and the liquid crystal layer 730 form the pixels.

The first substrate member 710 includes the first substrate 711, the first polarizer 712, the thin film transistors (not shown), the pixel electrode parts 713, phase difference parts 714, 715, and a first liquid crystal alignment layer 716.

The first substrate 711 has a plate shape. The first substrate 711 may include a transparent material. Examples of the transparent material that can be used for the first substrate 711 include glass and quartz.

The first polarizer 712 is positioned under the first substrate 711, and polarizes the light in the first polarizing direction. For example, the first polarizing direction may be about 0° with respect to a longitudinal direction of the first substrate 711. The backlight assembly that generates the internally provided light is positioned under the first polarizer 712. The internally provided light is polarized about 0° with respect to the longitudinal direction of the first substrate 711 by the first polarizer 712.

The thin film transistors are positioned on the first substrate 711. Each of the thin film transistors is electrically connected to each of the pixel electrode parts 713. The driving voltage is applied to each of the pixel electrode parts 713 through each of the thin film transistors.

The pixel electrode parts 713 are positioned on the first substrate 711 having the thin film transistors. Each of the pixel electrode parts 713 includes a transmission electrode 713a and a reflection electrode 713b. For example, the transmission electrode 713a may have substantially the same area as the reflection electrode 713b. The area of each of the transmission and reflection electrodes 713a and 713b may be about half of each of the pixel electrode parts 713. The transmission electrode 713a is in a transmission region of each of the pixel electrode parts 713. The transmission electrode 713a transmits a portion of the internally provided light generated from the backlight assembly. The reflection electrode 713b is in a reflection region of each of the pixel electrode parts 713. The externally provided light is reflected from the reflection electrode 713b.

The phase difference layer is formed on the pixel electrode parts 713. The phase difference layer includes a first phase difference part 714 and a second phase difference part 715. The first phase difference part 714 corresponds to the transmission region. The second phase difference part 715 corresponds to the reflection region. The phase difference layer compensates for differences of optical anisotropies formed by differences of a light path of the internally provided light and a light path of the externally provided light.

The first phase difference part 714 corresponds to the transmission region. The internally provided light passes through the first phase difference part 714. The first phase difference part 714 includes a first guiding layer 714a and a first optical anisotropy layer 714b.

The first guiding layer 714a is positioned on the pixel electrode parts 713 to guide an optical longitudinal direction of the first phase difference layer 714b. The first guiding layer 714a may be surface-treated in the optical longitudinal direction. The first optical anisotropy layer 714b is positioned on the first guiding layer 714a to change a phase of the internally provided light. A longitudinal axis of the first optical anisotropy layer 714b may be determined based on the surface-treatment of the first guiding layer 714a. For example, the longitudinal axis of the first optical anisotropy layer 714b may be about 0° with respect to the longitudinal direction of the first substrate 711.

The first optical anisotropy layer 714b converts a linearly polarized portion of the internally provided light into an elliptically polarized portion. The first optical anisotropy layer 714b changes a phase of the internally provided light by about 1/10λ to about ½λ. For example, the first optical anisotropy layer 714b may change the phase of the internally provided light by about ¼λ.

The second phase difference part 715 corresponds to the reflection region. The externally provided light passes through the second phase difference part 715. The second phase difference part 715 includes a second guiding layer 715a and a second optical anisotropy layer 715b.

The second guiding layer 715a is positioned on the pixel electrode parts 713 to guide the optical longitudinal direction of the second optical anisotropy layer 715b. The second guiding layer 715a may be surface-treated in an optical longitudinal direction. The optical longitudinal direction of the second guiding layer 715a may be different from the optical longitudinal direction of the first guiding layer 714a. The second optical anisotropy layer 715b is positioned on the second guiding layer 715a to change a phase of the internally provided light. A longitudinal axis of the second optical anisotropy layer 715b may be determined based on the surface-treatment of the second guiding layer 715a. For example, the longitudinal axis of the second optical anisotropy layer 715b may be about 45° or about 135° with respect to the longitudinal axis of the first optical anisotropy layer 714b. For example, the longitudinal axis of the second optical anisotropy layer 715b may be about 135° with respect to the optical longitudinal direction of the first optical anisotropy layer 714b.

The second optical anisotropy layer 715b includes an optical anisotropy material. For example, the second optical anisotropy layer 715b may include substantially the same light curable liquid crystal material as the first optical anisotropy layer 714b.

The second optical anisotropy layer 715b converts a linearly polarized portion of the internally provided light into an elliptically polarized portion. The second optical anisotropy layer 715b changes a phase of the internally provided light by about 1/10λ to about ½λ. For example, the second optical anisotropy layer 715b may change the phase of the internally provided light by about ¼λ.

The first liquid crystal alignment layer 716 is positioned on the phase difference layer. The first liquid crystal alignment layer 716 aligns the liquid crystals of the liquid crystal layer 730 in an alignment direction. For example, the alignment direction may be about 45° with respect to the longitudinal direction of the first substrate 711.

The second substrate member 720 corresponds to the first substrate member 710. The second substrate member 720 includes a second substrate 721, a second polarizer 722, a color filter (not shown), a common electrode 723 and a second alignment layer 724.

The second substrate 721 has a plane shape. The second substrate 721 may have substantially the same shape as the first substrate 711. The second substrate 721 may include a transparent material. Examples of the transparent material that can be used for the second substrate 721 include glass and quartz.

The second polarizer 722 is positioned on the second substrate 721, and polarizes the light in a second polarizing direction. For example, the second polarizing direction may be about 90° with respect to the longitudinal direction of the first substrate 711. The polarizing direction of the second polarizer 722 may be substantially the same as the first polarizing direction of the first polarizer 721. The internally provided light or the externally provided light is polarized about 90° with respect to the longitudinal direction of the first substrate 711 by the second polarizer 722.

The optical longitudinal direction of the first phase difference part 714 may be substantially the same as the first polarizing direction or the second polarizing direction. In addition, the optical longitudinal direction of the second phase difference part 715 may be substantially the same as the first polarizing direction or the second polarizing direction.

The color filter is formed on a lower surface of the second substrate 721 corresponding to the first substrate 711. A portion of the internally provided light or the externally provided light having a predetermined wavelength may pass through the color filter. The common electrode 723 is positioned on a lower surface of the second substrate 721 having the color filter. The common electrode 723 includes a transparent conductive material.

The second liquid crystal alignment layer 724 is positioned on a lower surface of the common electrode 723 to determine the alignment direction of the liquid crystal layer 730. The alignment direction of the second liquid crystal alignment layer 724 may be about 180° with respect to the alignment direction of the first liquid crystal alignment layer 714. Alternatively, the alignment direction of the second liquid crystal alignment layer 724 may be about 225° with respect to the alignment direction of the first liquid crystal alignment layer 714.

The liquid crystal layer 730 is interposed between the first substrate member 710 and the second substrate member 720. The liquid crystals of the liquid crystal layer 730 vary their arrangement in response to the electric field applied to the liquid crystal layer 730. The liquid crystals may have a positive dielectric anisotropy. A thickness of the liquid crystal layer 730 is adjusted so that the liquid crystal layer 730 has an optical anisotropy of about ¼λ. The liquid crystal layer 730 may have a horizontal alignment mode. Alternatively, the liquid crystal layer 730 may have a vertical alignment mode.

A protecting layer (not shown) may be formed between the phase difference layer and the first liquid crystal alignment layer 716 to protect the phase difference layer.

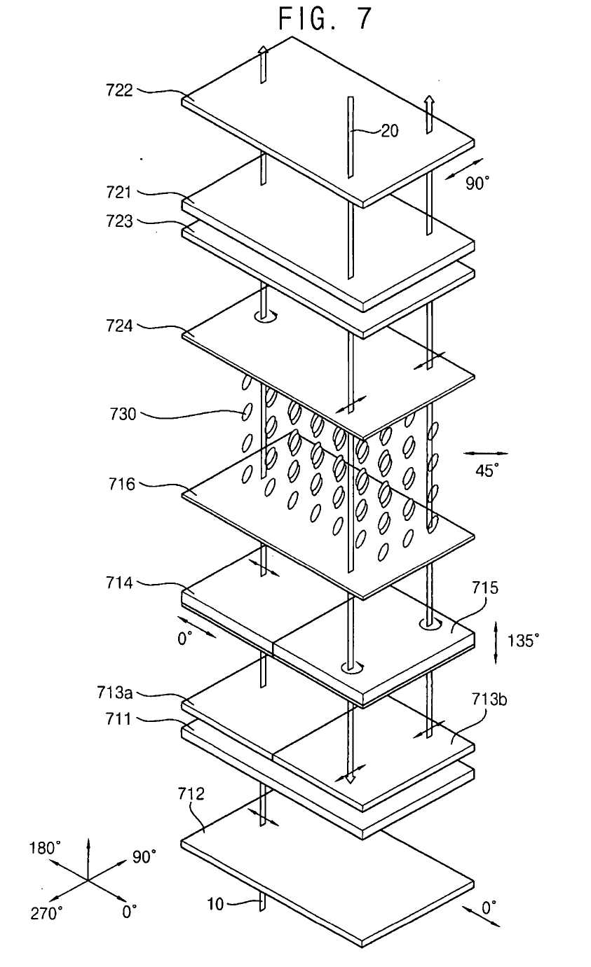

FIG. 7 is an exploded perspective view showing an operation of the pixel shown in FIG. 6 when electric power is not applied to the pixel. In FIG. 7, electric power is not applied to the pixel, and the liquid crystal layer functions as a ¼λ phase difference layer that converts a linearly polarized light into a circularly polarized light. Light paths of the internally provided light generated from the backlight and the externally provided light are described, in sequence.

Referring to FIGS. 6 and 7, the internally provided light 10 generated from the backlight assembly passes through the first polarizer 712 to be linearly polarized in about 0° or about 180° with respect to the longitudinal direction of the first substrate 711. The linearly polarized light passes through the first substrate 711, the transmission electrode 713a, the first phase difference part 714 and the first liquid crystal alignment layer 716, in sequence. The linearly polarized light having passed through the first substrate 711, the transmission electrode 713a, the first phase difference part 714 and the first liquid crystal alignment layer 716 is incident into the liquid crystal layer 730 having a longitudinal axis of about 45° or about 225° to be circularly polarized. The circularly polarized light passes through the second liquid crystal alignment layer 724, the common electrode 723 and the second substrate 721. The circularly polarized light having passed through the second liquid crystal alignment layer 724, the common electrode 723 and the second substrate 721 passes through the second polarizer 722 having the polarizing direction of about 90° or about 270° to display a white image.

The externally provided light 20 passes through the second polarizer 722 to be linearly polarized about 90° or about 270° with respect to the longitudinal direction of the first substrate 711. The linearly polarized light passes through the second substrate 721, the common electrode 723 and the second liquid crystal alignment layer 724, in sequence. The linearly polarized light having passed through the second substrate 721, the common electrode 723 and the second liquid crystal alignment layer 724 is incident into the liquid crystal layer 730 having the longitudinal axis of about 45° or about 225° to be circularly polarized. The circularly polarized light is incident into the second phase difference part 715 to be linearly polarized about 90° or about 270° with respect to the longitudinal direction of the first substrate 711. The linearly polarized light is reflected from the reflection electrode 713b.

The reflected linearly polarized light passes through the second phase difference part 715 to be circularly polarized. The circularly polarized light passes through the second liquid crystal alignment layer 716. The circularly polarized light having passed through the second liquid crystal alignment layer 716 is incident into the liquid crystal layer 730 to be linearly polarized about 90° or about 270°. The linearly polarized light passes through the second liquid crystal alignment layer 724, the common electrode 723 and the second substrate 721, in sequence. The linearly polarized light having passed through the second liquid crystal alignment layer 724, the common electrode 723 and the second substrate 721 passes through the second polarizer 722 to display the white image.

Therefore, when electric power is not applied to the pixel, the internally provided light 10 and the externally provided light 20 pass through the second polarizer 722 to display the white image.

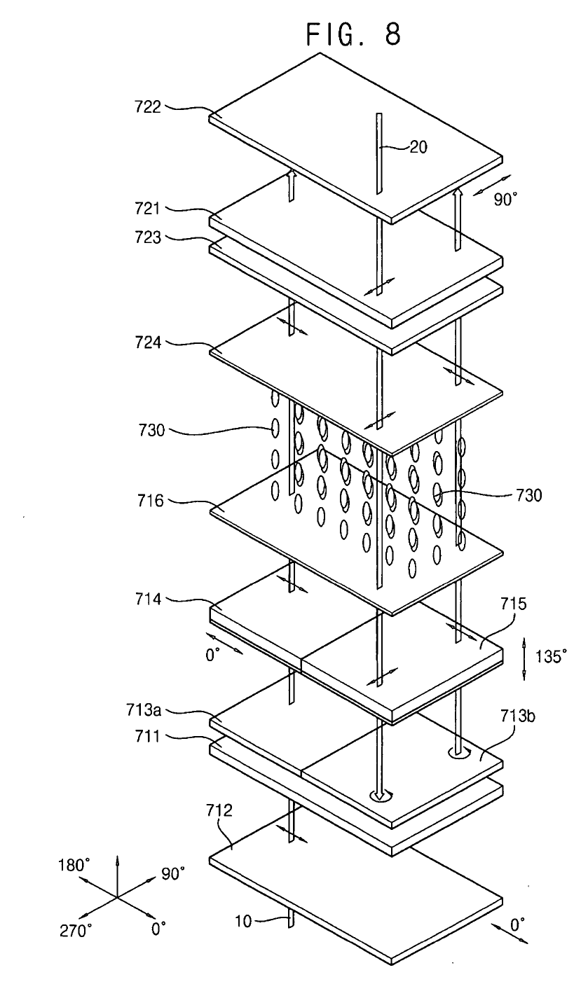

FIG. 8 is an exploded perspective view showing an operation of the pixel shown in FIG. 6 when electric power is applied to the pixel. In FIG. 8, electric power is applied to the pixel, and the liquid crystal layer has the vertical alignment mode that transmits the internally provided light or the externally provided light. Light paths of the internally provided light generated from the backlight assembly and the externally provided light are described, in sequence.

Referring to FIGS. 6 and 8, the internally provided light 10 generated from the backlight assembly passes through the first polarizer 712 to be linearly polarized about 0° or about 180° with respect to the longitudinal direction of the first substrate 711. The linearly polarized light passes through the first substrate 711, the transmission electrode 713a, the first phase difference part 714 and the first liquid crystal alignment layer 716, in sequence. The linearly polarized light having passed through the first substrate 711, the transmission electrode 713a, the first phase difference part 714 and the first liquid crystal alignment layer 716 also passes through the liquid crystal layer 730 having the vertical alignment mode. The linearly polarized light passes through the liquid crystal layer 730, the second liquid crystal alignment layer 724, the common electrode 723 and the second substrate 721, in sequence. The linearly polarized light having passed through the second liquid crystal alignment layer 724, the common electrode 723 and the second substrate 721 is blocked by the second polarizer 722 having the polarizing direction of about 90° or about 270°.

The externally provided light 20 passes through the second polarizer 722 to be linearly polarized about 90° or about 270° with respect to the longitudinal direction of the first substrate 711. The linearly polarized light passes through the second substrate 721, the common electrode 723 and the second liquid crystal alignment layer 724, in sequence. The linearly polarized light having passed through the second substrate 721, the common electrode 723 and the second liquid crystal alignment layer 724 also passes through the liquid crystal layer 730. The linearly polarized light having passed through the liquid crystal layer 730 also passes through the first liquid crystal alignment layer 716. The linearly polarized light having passed through the first liquid crystal alignment layer 716 is incident into the second phase difference layer 715 having the optical longitudinal direction of about 135° to about 315° to be circularly polarized. The circularly polarized light that is formed by the second phase difference layer 715 is characterized as original circularly polarized light. The original circularly polarized light is reflected from the reflection electrode 713b. The reflected circularly polarized light may have a substantially opposite direction to the original circularly polarized light.

The reflected circularly polarized light is incident into the second phase difference layer 715 to be linearly polarized about 0° to about 180°. The linearly polarized light passes through the first liquid crystal alignment layer 716, the liquid crystal layer 730, the second liquid crystal alignment layer 724, the common electrode 723 and the second substrate 721. The linearly polarized light having passed through the first liquid crystal alignment layer 716, the liquid crystal layer 730, the second liquid crystal alignment layer 724, the common electrode 723 and the second substrate 721 is blocked by the second polarizer 722 having the polarizing direction of about 90° or about 270°.

Therefore, when electric power is applied to the pixel, the internally provided light 10 and the externally provided light 20 are blocked by the second polarizer 722 to display a black image.

In addition, an amount of the electric power applied to the pixel is adjusted to control a gray-scale of the image. Usually, a voltage between the voltage that is applied in a bright state and the voltage that is applied in a dark state is applied to obtain the gray-scale image.

In FIGS. 7 and 8, when electric power is not applied to the pixel, the liquid crystal layer 730 functions as the ¼λ phase different layer that converts the linearly polarized light into the circularly polarized light. In addition, when electric power is applied to the pixel, the liquid crystal layer 730 transmits the linearly polarized light. Alternatively, when electric power is not applied to the pixel, the liquid crystal layer may transmit the linearly polarized light, and, when electric power is applied to the pixel, the liquid crystal layer may function as the ¼λ phase different layer that converts the linearly polarized light into the circularly polarized light.

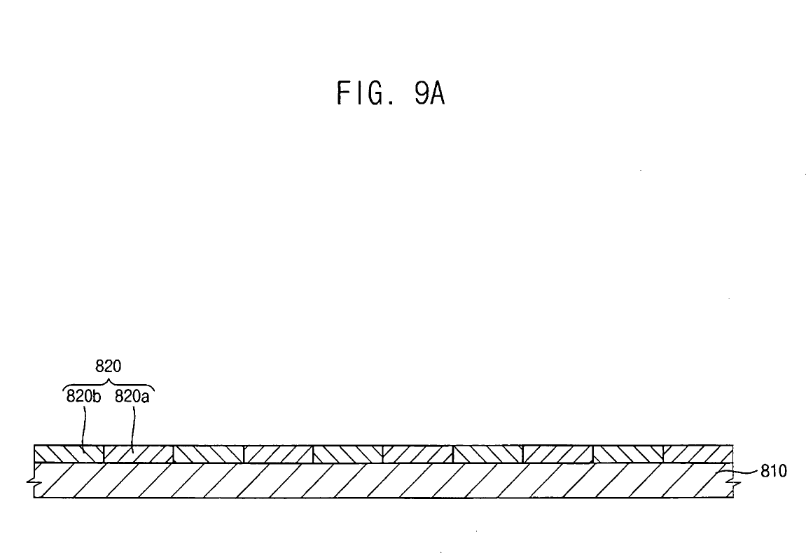

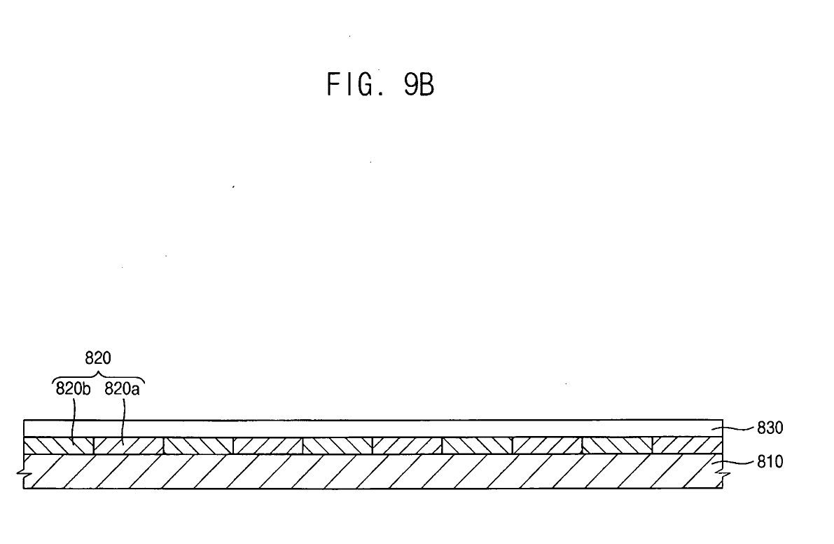

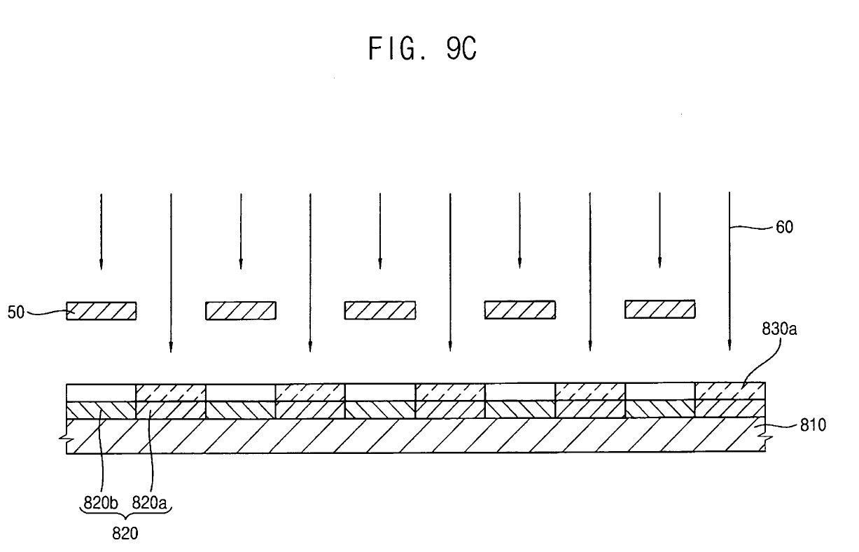

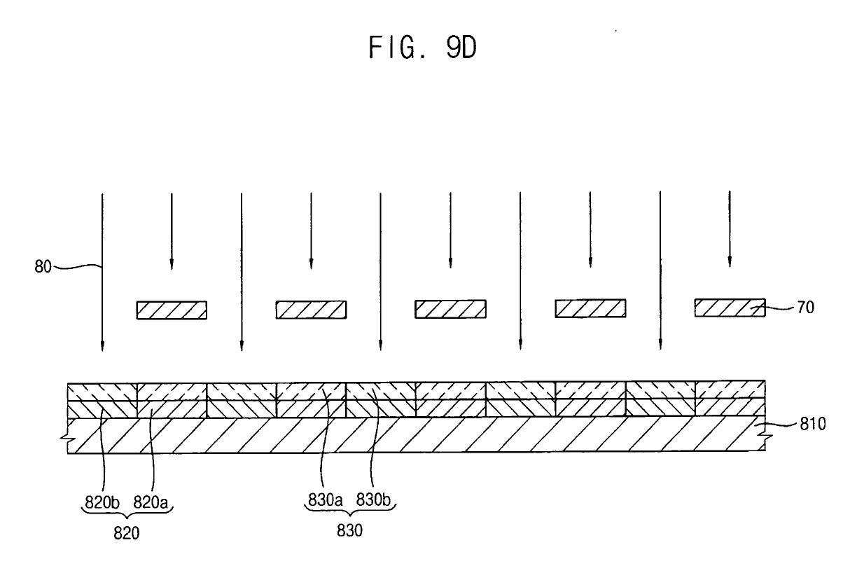

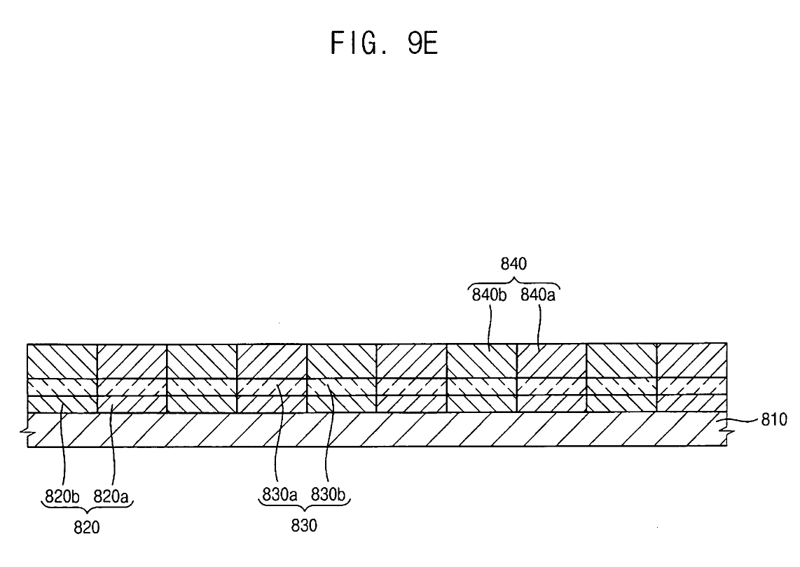

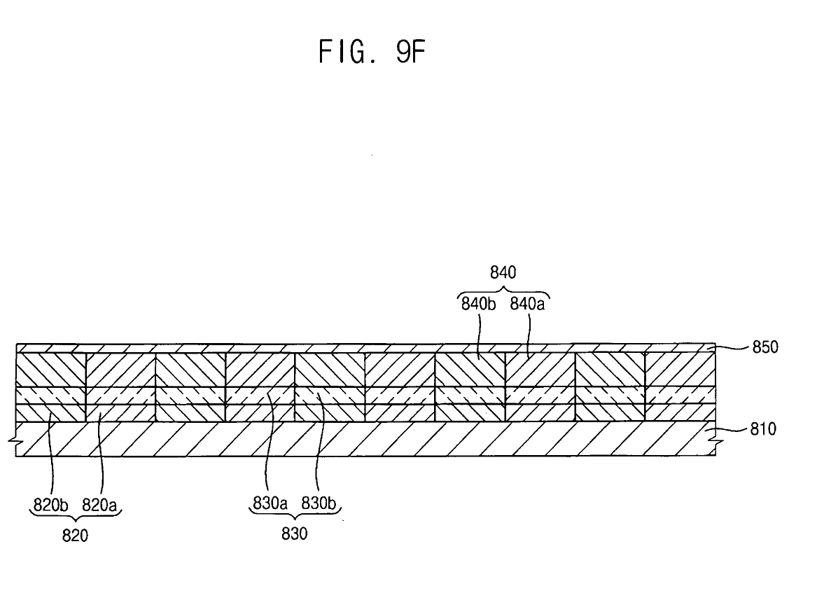

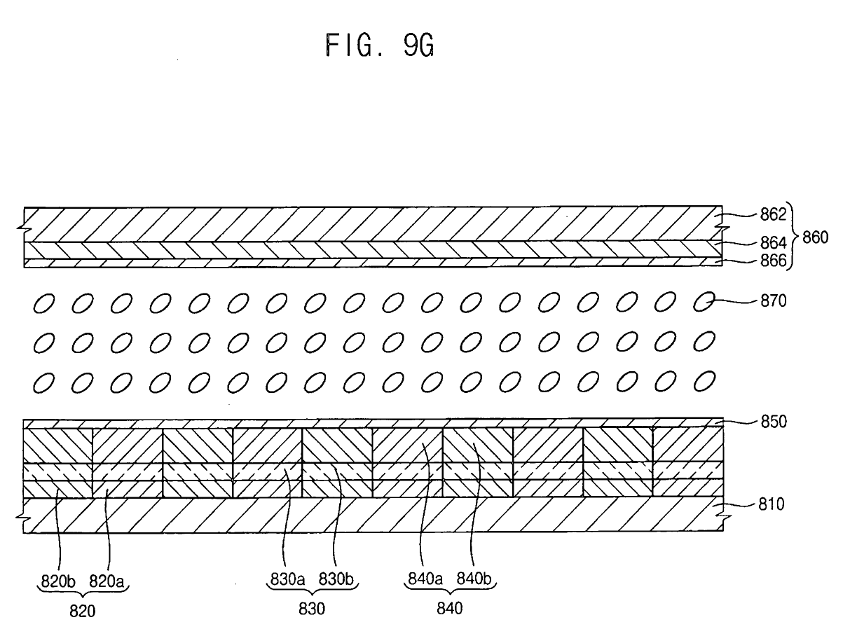

FIGS. 9A to 9G are cross-sectional views showing a method of manufacturing a display panel in accordance with an embodiment of the present invention.

FIG. 9A is a cross-sectional view showing a plurality of pixel electrode parts on a first substrate in accordance with an embodiment of the present invention.

Referring to FIG. 9A, the pixel electrode parts 820 are formed on the first substrate 810. Each of the pixel electrode parts 820 includes a transmission electrode 820a and a reflection electrode 820b. The transmission electrode 820a of each of the pixel electrode parts 820 transmits an internally provided light. An externally provided light is reflected from the reflection electrode 820b of each of the pixel electrode parts 820. For example, the transmission electrode 820a and the reflection electrode 820b may be deposited on the first substrate 810 through plasma enhanced chemical vapor deposition processes and/or sputtering processes. In FIG. 9A, the transmission electrode 820a is formed on the first substrate 810, and the reflection electrode 820b is formed on the first substrate 810 having the transmission electrode 820a.

FIG. 9B is a cross-sectional view showing a guiding layer formed on the pixel electrode parts shown in FIG. 9A.

Referring to FIG. 9B, the guiding layer 830 is formed on the pixel electrode parts 820. The guiding layer 830 may be formed through, for example, a coating process and/or a deposition process. The guiding layer 830 includes a high polymer. Examples of the high polymer that can be used for the guiding layer 830 include SE-7492 manufactured Nissan Chemical Corporation, Japan, and JALS203 manufactured JSR Corporation, Japan.

FIG. 9C is a cross-sectional view showing an electromagnetic wave irradiated onto a portion of the guiding layer shown in FIG. 9B.

Referring to FIG. 9C, a first electromagnetic wave 60 is irradiated onto a first guiding region 830a of the guiding layer 830. For example, the first electromagnetic wave 60 is an ultraviolet light polarized in a first direction, and a wavelength of the ultraviolet light is no more than about 400 nm. The first electromagnetic wave 60 is irradiated onto the first guiding region 830a of the guiding layer through a first mask 50. The first guiding region 830a corresponds to the transmission region. When the first electromagnetic wave 60 is irradiated onto the first guiding region 830a, the first guiding region 830a of the guiding layer 830 has an anisotropy. Alternatively, electrons or ions may impact the first guiding region 830a of the guiding layer 830.

FIG. 9D is a cross-sectional view showing an electromagnetic wave irradiated on another portion of the guiding layer shown in FIG. 9C.

Referring to FIG. 9D, a second electromagnetic wave 80 is irradiated onto a second guiding region 830b of the guiding layer 830. The first guiding region 830a is different from the second guiding region 830b. The second electromagnetic wave 80 is an ultraviolet light polarized in a second direction that is different from the first direction, and a wavelength of the ultraviolet light is no more than about 400 nm. The second electromagnetic wave 80 is irradiated onto the second guiding region 830b of the guiding layer through a second mask 70. The second guiding region 830b corresponds to the reflection region. When the second electromagnetic wave 80 is irradiated onto the second guiding region 830b, the second guiding region 830b of the guiding layer 830 has an anisotropy. Alternatively, electrons or ions may impact the second guiding region 830b of the guiding layer 830.

FIG. 9E is a cross-sectional view showing an optical anisotropy layer on the guiding layer shown in FIG. 9D.

Referring to FIG. 9E, the optical anisotropy layer 840 is formed on the guiding layer 830. The optical anisotropy layer 840 includes an optical anisotropy material. The optical anisotropy layer 840 may be formed through, for example, a spin coating process and/or a roll coating process. The optical anisotropy layer 840 includes a first optical anisotropy portion 840a and a second optical anisotropy portion 840b. The first optical anisotropy portion 840a is in the first guiding region 830a. The second optical anisotropy portion 840b is in the second guiding region 830b. A longitudinal axis of the first optical anisotropy portion 840a forms an angle of about 45° or about 135° with respect to a longitudinal axis of the second optical anisotropy portion 840b.

FIG. 9F shows a first liquid crystal alignment layer on the optical anisotropy layer 840 shown in FIG. 9E.

Referring to FIG. 9F, the first liquid crystal alignment layer 850 is formed on the optical anisotropy layer 840. Alternatively, a protecting layer (not shown) may be formed on the optical anisotropy layer 840 before the first liquid crystal alignment layer 850 is formed.

FIG. 9G is a cross-sectional view showing a second substrate member and a liquid crystal layer on the first liquid crystal alignment layer shown in FIG. 9F.

Referring to FIG. 9G, the second substrate member 860 is aligned with the first substrate 810. The second substrate member 860 includes a second substrate 862, a common electrode 864 and a second liquid crystal alignment layer 866. The liquid crystal layer 870 is interposed between the first and second liquid crystal alignment layers 850 and 866.

In FIGS. 9A to 9G, the guiding layer 830 and the optical anisotropy layer 840 are on the first substrate 810. Alternatively, the guiding layer and the optical anisotropy layer may be on the second substrate 862.

According to embodiments of the present invention, the phase difference layer is formed in the display panel to compensate for the optical anisotropies of the display panel. Therefore, the thickness of the display panel may be decreased. In addition, an image display quality of the display panel is improved, and a manufacturing process of the display panel is simplified.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A display panel comprising:
a first substrate member including a first substrate and a pixel electrode part on the first substrate, wherein the pixel electrode part transmits an internally provided light and reflects an externally provided light;
a second substrate member including a second substrate and a common electrode on the second substrate;
a liquid crystal layer interposed between the first and second substrate members; and
a phase difference layer between the first and second substrates to change phases of the internally and externally provided light.

2. The display panel of claim 1, wherein the phase difference layer is on the pixel electrode part.

3. The display panel of claim 1, wherein the phase difference layer is on the common electrode.

4. The display panel of claim 1, wherein the phase difference layer comprises:
an optical anisotropy layer; and
a guiding layer controlling an optical longitudinal direction of the optical anisotropy layer.

5. The display panel of claim 1, wherein the pixel electrode part comprises:
a transmission electrode that transmits the internally provided light in a transmission region; and
a reflection electrode that reflects the externally provided light in a reflection region.

6. The display panel of claim 5, wherein the internally provided light is generated under the first substrate member, and the externally provided light is generated on the second substrate member.

7. The display panel of claim 5, wherein the phase difference layer comprises:
a first phase difference portion corresponding to the transmission region; and
a second phase difference portion corresponding to the reflection region.

8. The display panel of claim 7, wherein an optical longitudinal direction of the first phase difference portion forms an angle of about 45° with respect to an optical longitudinal direction of the second phase difference portion.

9. The display panel of claim 7, wherein an optical longitudinal direction of the first phase difference portion forms an angle of about 135° with respect to an optical longitudinal direction of the second phase difference portion.

10. The display panel of claim 7, further comprising a first polarizer on the first substrate and a second polarizer on the second substrate, wherein an optical longitudinal direction of the first phase difference layer is substantially in parallel with a polarizing axis of the first polarizer or the second polarizer.

11. The display panel of claim 7, further comprising a first polarizer on the first substrate and a second polarizer on the second substrate, wherein an optical longitudinal direction of the second phase difference layer is substantially in parallel with a polarizing axis of the first polarizer or the second polarizer.

12. The display panel of claim 1, further comprising a first polarizer on the first substrate and a second polarizer on the second substrate, wherein a polarizing axis of the first polarizer forms an angle of about 90° with respect to a polarizing axis of the second polarizer.

13. The display panel of claim 1, wherein the phase difference layer changes a linearly polarized light to an elliptically polarized light.

14. The display panel of claim 1, wherein the phase difference layer changes a phase of the internally provided light and a phase of the externally provided light by about 1/10λ to about ½λ.

15. The display panel of claim 14, wherein the phase difference layer changes a phase of the internally provided light and a phase of the externally provided light by about ¼λ.

16. The display panel of claim 1, wherein the phases of the internally and externally provided light are changed by different amounts.

17. A method of manufacturing a display panel comprising:
forming a pixel electrode part on a first substrate, wherein the pixel electrode part transmits an internally provided light and reflects an externally provided light;
forming a common electrode on a second substrate; and
forming at least one phase difference layer on at least one of the pixel electrode part or the common electrode, wherein the phase difference layer changes phases of the internally and externally provided light by different amounts.

18. The method of claim 17, wherein the phase difference layer comprises:
an optical anisotropy layer; and
a guiding layer controlling an optical longitudinal direction of the optical anisotropy layer.

19. The method of claim 18, wherein the optical anisotropy layer comprises an optical anisotropy material.

20. The method of claim 18, wherein forming the phase difference layer comprises:
forming the guiding layer on at least one of the pixel electrode part or the common electrode;
surface-treating the guiding layer;
forming the optical anisotropy layer on the surface-treated guiding layer; and
aligning and solidifying the optical anisotropy layer on the surface-treated guiding layer.

21. The method of claim 20, wherein:
the pixel electrode part comprises a transmission electrode that transmits the internally provided light in a transmission region, and a reflection electrode that reflects the externally provided light in a reflection region, and
the guiding layer comprises a first guiding portion in the transmission region and a second guiding portion in the reflection region, the first and second guiding portions being surface-treated in different directions.

22. The method of claim 20, wherein surface-treating the guiding layer comprises:
aligning a mask on the guiding layer; and
irradiating an electromagnetic wave on the guiding layer through the mask to treat a surface of the guiding layer.

23. The method of claim 22, wherein the electromagnetic wave comprises an ultraviolet light.

24. The method of claim 22, wherein a wavelength of the electromagnetic wave is no more than about 400 nm.

25. The method of claim 20, wherein surface-treating the guiding layercomprises:
aligning a mask on the guiding layer; and
impacting accelerated particles on the guiding layer through the mask to treat a surface of the guiding layer.

26. A display device comprising:
a backlight assembly generating an internally provided light; and
a display panel including:
a first substrate member including a first substrate and a pixel electrode part on the first substrate, wherein the pixel electrode part transmits the internally provided light and reflects an externally provided light;
a second substrate member including a second substrate and a common electrode on the second substrate;
a liquid crystal layer interposed between the first and second substrate members; and
a phase difference layer between the first and second substrates to change phases of the internally and externally provided light by different amounts.

27. The display device of claim 26, wherein the pixel electrode part comprises:
a transmission electrode that transmits the internally provided light in a transmission region; and
a reflection electrode that reflects the externally provided light in a reflection region.
